(19) United States
(12) Patent Application Publication
(10) Pub. No.: US 2014/0102423 A1
(43) Pub. Date: Apr. 17, 2014

(54) INTAKE SYSTEM FOR AN INTERNAL COMBUSTION ENGINE

(71) Applicant: GM GLOBAL TECHNOLOGY OPERATIONS LLC, Detroit, MI (US)

(72) Inventors: Shawn Michael Owen, Ortonville, MI (US); Travis Sperow, Davisburg, MI (US)

(73) Assignee: GM GLOBAL TECHNOLOGY OPERATIONS LLC, Detroit, MI (US)

(21) Appl. No.: 13/649,579

(22) Filed: Oct. 11, 2012

(51) Int. Cl. F02M 15/00

(52) U.S. Cl. 123/542

(57) ABSTRACT

An air intake system for delivering induction air to a cylinder head of an internal combustion engine, including an intake plenum assembly mounted to an intake manifold, wherein the intake manifold is mounted to the cylinder head and an airflow cooler module mounted to the intake plenum. The air intake system also includes a throttle body and heat exchanger disposed in the airflow cooler module between an induction air inlet of the airflow cooler module and the intake plenum, wherein an induction air flow path extends from the induction air inlet, through the heat exchanger and the intake plenum to the cylinder head of the internal combustion engine.

### FIELD OF THE INVENTION

Exemplary embodiments of the present invention relate to air intake systems for internal combustion engines and, more particularly, to an intake manifold module including directly mounted charge air cooler(s) and throttle body.

### BACKGROUND

Internal combustion engines utilizing charge air induction are typically comprised of one or more exhaust driven turbochargers or an engine driven supercharger to deliver charge air to the intake manifold. In the case of a dual or twin turbocharger engine configuration, ducts from the turbochargers may combine the compressed induction air and pass the charge through a charge air cooler. A duct or plenum extending from the outlet of the charge air cooler delivers cooled, compressed charge air to a throttle body that is mounted externally to a traditional intake manifold.

The charge air cooler is typically mounted in the under hood area of the vehicle near the coolant radiator and the air conditioner condenser coil (i.e. near the front of the vehicle) which result in air ducts to and from the charge air cooler that are long and subject to packaging, noise and vibration issues. Seals between the ducts and the various components present opportunities for leakage and the length of the ducts can have a deleterious effect on transient performance of the internal combustion engine. Additionally, the ducts from the turbocharger to the charge air cooler, and the ducts returning from the charge air cooler to the throttle body contain a significant air volume that must also be compressed during boosted operation. The additional volume delays the pressure head of the charge air entering the engine's cylinders contributing to what is commonly referred to as “turbo lag”.

To reduce turbo lag and improve overall system packaging, charge air coolers that are integrated directly into an intake module of an internal combustion engine have been introduced. Most often the intake module mounted charge air coolers are air-to-liquid type coolers, rather than air-to-air type.

### SUMMARY OF THE INVENTION

In an exemplary embodiment, an air intake system for delivering induction air to a cylinder head of an internal combustion engine, includes an intake plenum assembly mounted to an intake manifold, wherein the intake manifold is mounted to the cylinder head and an airflow cooler module mounted to the intake plenum. The air intake system also includes a heat exchanger disposed in the airflow cooler module between an induction air inlet of the airflow cooler module and the intake plenum, wherein an induction air flow path extends from the combustion air inlet, through the heat exchanger and the intake plenum to the cylinder head of the internal combustion engine.

In another exemplary embodiment, an airflow cooler module for supplying induction air to an internal combustion engine includes an air inlet disposed on a first end of the airflow cooler module and an open face disposed on a second end of the airflow cooler module, wherein the second end is opposite and downstream the airflow path of the first end. The airflow cooler module also includes a heat exchanger disposed between a induction air inlet of the airflow cooler module and the open face, wherein the open face is configured to mount directly to an intake plenum. The heat exchanger is an air-to-liquid type exchanger, comprised of a coolant fluid inlet and outlet ports. The cooling fluid may be communicated via plumbing to either the internal combustion engine cooling system, or its own closed loop cooling system. The heat exchanger transfers thermal energy from the higher temperature incoming compressed air to the outgoing coolant fluid, where the thermal energy is then rejected from the coolant to the surrounding environment through a cooling system radiator.

The above features and advantages, and other features and advantages of the present invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of the embodiments, the detailed description referring to the drawings in which:

FIG. 1 is a perspective view of an air intake system for an internal combustion engine having an externally mounted airflow cooler module embodying features of the invention;

FIG. 2 is a cross sectional side view of an internal combustion engine having an externally mounted airflow cooler module embodying features of the invention; and

FIG. 3 is a disassembled perspective view of an internal combustion engine having an externally mounted airflow cooler module embodying features of the invention.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

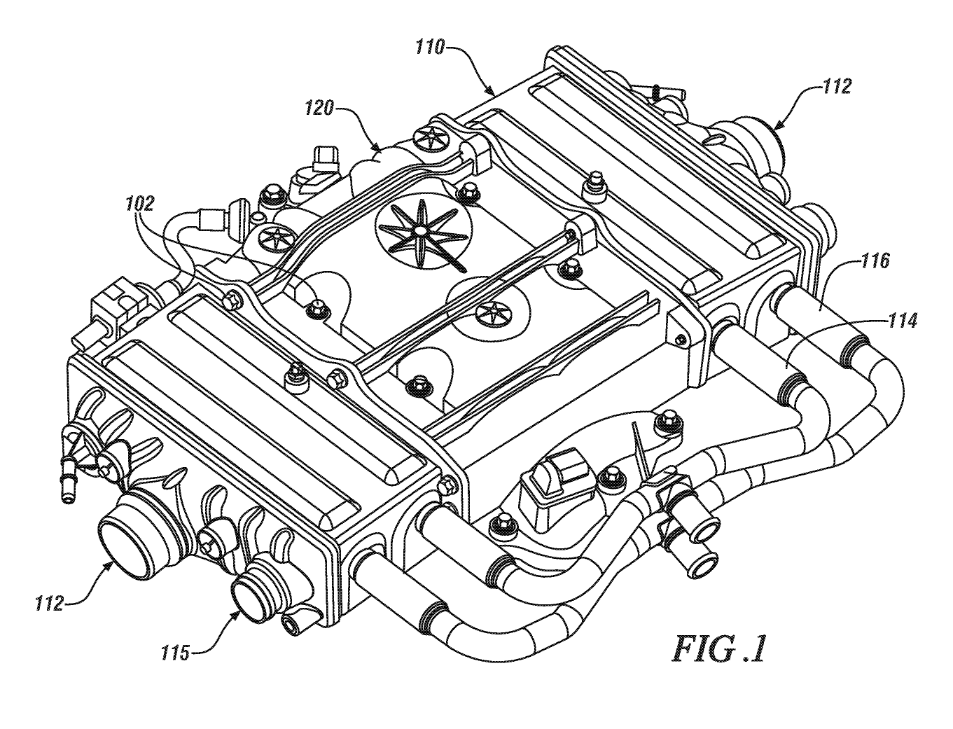

Referring now to FIG. 1, a perspective view of an air intake system for an internal combustion engine (not shown) in accordance with exemplary embodiments is shown. The air intake system includes an airflow cooler module 110 that is mounted to an intake plenum 120, which mounted to an intake manifold (140, not shown). The airflow cooler module 110 includes an induction air inlet 112, a cooling inlet 114 and a cooling outlet 116.

In exemplary embodiments, the airflow cooler module 110 is directly mounted and fastened to the intake plenum 120. In exemplary embodiments, the airflow cooler module 110 may also include a turbo by-pass port 115 and pressure port, which are configured to ensure that the air pressure inside the airflow cooler module 110 does not exceed a predetermined maximum value.

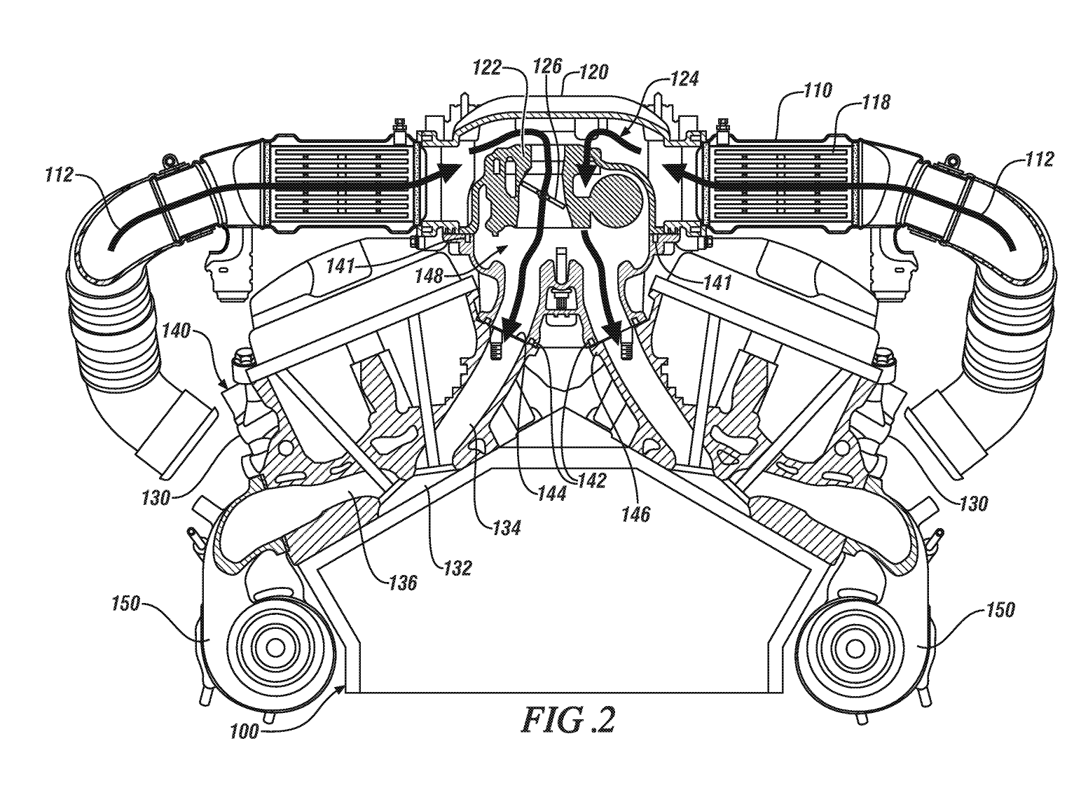

Referring now to FIG. 2, a cross sectional side view of an airflow cooler module 110 externally mounted to an internal combustion engine 100 in accordance with exemplary embodiments is shown. The internal combustion engine 100 includes one or more cylinder heads 130 having a plurality of combustion chambers 132 in fluid communication with valved intake ports 134 and exhaust ports 136. The valved intake ports 134 receive induction air from intake plenum and deliver the intake air to the combustion chambers 132 for mixing with fuel and combustion therein. Products of the combusted air and fuel (i.e. exhaust gas) exit the valved exhaust ports 136 and flow through exhaust driven turbochargers 150 that extract energy from the exhaust gas and utilize it to compress induction air for delivery to the induction air inlet 112 of the airflow cooler module 110.

In exemplary embodiments, an air intake system includes an airflow cooler module 110 that is mounted to the intake plenum 120 of the internal combustion engine 100. The intake plenum 120 is mounted to an intake manifold 140 which is mounted to the cylinder head 130 utilizing a gasket 142 that is disposed between the port openings 144 of the valved intake ports 134 of cylinder head 130 and induction air outlets 146 of the intake manifold 140. The intake manifold 140 is mounted to the cylinder head 130 using a plurality of bolts or other suitable fasteners. The gasket 142 and the bolt clamp load define a positive seal between the port openings 144 of the cylinder head 130 and the induction air outlets 146 of the intake manifold 140. The intake manifold 140 may include provision for the mounting of a manifold absolute pressure and temperature sensor, fuel purge system plumbing, brake vacuum plumbing, as well as a port for receiving a positive crankcase ventilation system plumbing (not shown). The intake plenum 120 is mounted to, and encloses the plenum air volume area, to the intake manifold 140. The intake plenum housing 120 and the intake manifold 140 are configured for assembly in a sealing relationship along perimeter flanges 141 through the use of bolts (not shown) or other suitable fasteners for holding the two assemblies together in a sealed relationship.

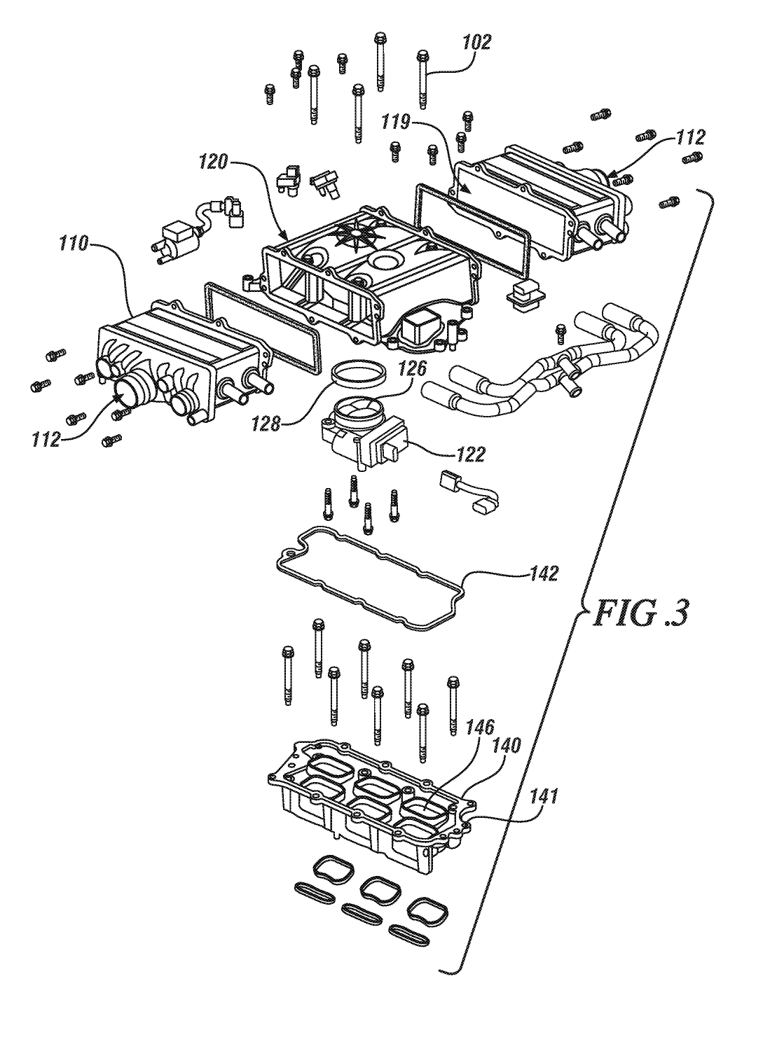

As shown in FIG. 2, a throttle body 122 is disposed within the intake plenum 120. The throttle body 122 operates to separate a plenum volume 124 and a manifold volume 148 and includes a throttle blade 126, disposed therein, that meters induction air through the intake plenum 120 and to the intake ports 134 of the cylinder head 130. In the embodiment illustrated in the FIGS. 2-3, the throttle body 122 is disposed within the intake plenum 120 and may include an integral gasket 128 to seal the downstream throttle bore of the throttle body 122 thereto. The seal 128 is effective to avoid unmetered induction air leaks around the throttle body 122 and throttle blade 126 that would allow induction air to flow from the plenum volume 124 to the manifold volume 148 (i.e. around the throttled portion of the air intake system).

In an exemplary embodiment, the airflow cooler module 110 includes a heat exchanger 118 that is disposed within the airflow cooler module 110. In the exemplary embodiment, the heat exchanger 118 may comprise an air-to-air exchanger or, as illustrated in the Figures, a water-to-air heat exchanger that is in fluid communication with a cooling system (not shown) through a cooling inlet 114 and a cooling outlet 116.

In exemplary embodiments, as best illustrated in FIG. 3, the airflow cooler module 110 includes an induction air inlet 112 disposed on one end of the airflow cooler module 110 and an open face 119 disposed on an opposing end. In exemplary embodiments, the open face 119 is configured to be mounted directly to the intake plenum 120.

In an exemplary embodiment, during operation of the internal combustion engine 100, hot compressed induction air from the exhaust driven turbochargers 150 enters air inlet 112 of the airflow cooler module 110. The induction air inlet 112 is in fluid communication with the heat exchanger 118, which operates to receive the hot compressed induction air. The hot compressed induction air is distributed within the airflow cooler module 110 upstream of the heat exchanger 118 thereby increasing the volume utilization of the exchangers, which increases system efficiency and maximizes the removal of excess heat from the hot compressed induction air.

Hot compressed induction air flows through the heat exchanger 118 where it is cooled, in a known manner, before entering the intake plenum 120 and combining into a unified induction air flow of cooled compressed induction air. The cooled compressed induction air is metered by the throttle blade 126 of the throttle body 122 as it flows from the plenum volume 124 to the manifold volume 148 where it exits the intake manifold 140, through induction air outlets 146, and enters the valved intake ports 134 of the internal combustion engine 100.

While the invention had been described thus far as applicable to a V-configured internal combustion engine 130 having twin, exhaust driven turbochargers 150, it is contemplated that the invention has equally beneficial application to internal combustion engines of other configurations. Such configurations may include inline configured engines having a single exhaust driven turbocharger or an engine driven supercharger in which case the configuration of the airflow cooler module may only, but not necessarily, require a single heat exchanger 118 and a single induction air inlet.

In the exemplary embodiment, an intake plenum 120 and intake manifold 140 define a single induction air inlet through which cooled compressed induction air is received from an airflow cooler module 110. Hot induction air from one or more exhaust driven turbochargers enters the airflow cooler module 110 via an air intake 112 and cooled and provided to the intake plenum 120. The cooled compressed induction air is metered by the throttle blade 126 of the throttle body 122 as it flows from the plenum volume 124 to the manifold volume 148 where it exits through induction air outlets 146, and enters the valved intake ports 134 of the internal combustion engine 100 for mixing with fuel and combustion thereof in the combustion chambers 132.

In exemplary embodiments, by providing one or more airflow cooler modules 110 that are separate from, and directly mounted to the intake plenum 120, the heat rejection of the airflow cooler modules 110 is increased, as compared to similar integrated airflow cooler modules.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

1. An air intake system for delivering induction air to a cylinder head of an internal combustion engine, comprising:
an intake plenum assembly mounted to an intake manifold, wherein the intake manifold is mounted to the cylinder head;
an airflow cooler module comprising an induction air inlet disposed on a first end of the airflow cooler module and an open face disposed on a second end of the airflow cooler module, wherein the airflow cooler module is separate from the intake plenum to increase a heat rejection of the airflow cooler module and wherein the second end of the airflow cooler module is mounted to the intake plenum assembly;
a heat exchanger disposed in the airflow cooler module between the induction air inlet of the airflow cooler module and the intake plenum assembly, wherein an induction air flow path extends from the induction air inlet, through the heat exchanger and the intake plenum assembly to the cylinder head of the internal combustion engine;
a throttle body disposed within the intake plenum assembly and operable to define a plenum volume and a manifold volume; and
a throttle blade disposed in the throttle body to meter induction air through the airflow cooler module from the plenum volume to the manifold volume and to intake ports of the cylinder head.

2. The air intake system of claim 1, further comprising an induction air conduit in fluid communication with the induction air inlet and configured to deliver induction air from an exhaust driven turbocharger to the airflow cooler module.

3. The air intake system of claim 1, further comprising:
a second airflow cooler module mounted to the intake plenum assembly; and
a second heat exchanger disposed in the second airflow cooler module between a second induction air inlet of the second airflow cooler module and the intake plenum assembly, wherein a second induction air flow path extends from the second induction air inlet, through the second heat exchanger and the intake plenum assembly to the cylinder head of the internal combustion engine.

4. (canceled)

5. The air intake system of claim 1, wherein the heat exchanger is a water-to-air heat exchanger that is in fluid communication with a cooling system through a water manifold.

6. The air intake system of claim 1, wherein the airflow cooler module further comprises a turbo by-pass port configured to ensure that an air pressure inside the airflow cooler module does not exceed a predetermined maximum value.

7. (canceled)

8. (canceled)
